(19) United States
(12) Patent Application Publication
(10) Pub. No.: US 2006/0069200 A1
(43) Pub. Date: Mar. 30, 2006

(54) Acrylic adhesive composition and acrylic adhesive sheet

(75) Inventors: Kazunori Kondo, Kashima-gun (JP); Shigehiro Hoshida, Narita-shi (JP); Michio Aizawa, Chiba-shi (JP); Tadashi Amano, Kashima-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Shin-Etsu Chemical Co., Ltd., Tokyo (JP)

(21) Appl. No.: 11/236,515

(22) Filed: Sep. 28, 2005

(30) Foreign Application Priority Data
Sep. 29, 2004 (JP) 2004-283551

(51) Int. Cl. C09B 67/00

(52) U.S. Cl. 524/502

(57) ABSTRACT

Provided is an acrylic adhesive composition, including: (A) 100 parts by mass of an acrylic polymer containing a carboxyl group, with a glass transition temperature of 5 to 30° C., (B) 1 to 20 parts by mass of a resol-type phenol resin, (C) 1 to 20 parts by mass of an epoxy resin, and (D) 10 to 100 parts by mass of an inorganic filler, the composition optionally including 0 to 0.5 parts by mass of a curing accelerator per 100 parts by mass of the component (A). Also provided are an acrylic adhesive sheet that contains an adhesive layer including this composition and a method of bonding two substrates using this acrylic adhesive sheet. The acrylic adhesive sheet exhibits excellent adhesiveness, heat resistance, workability, handling properties and storage stability, and the acrylic adhesive composition is useful in the production of such an adhesive sheet.

### BACKGROUND OF THE INVENTION

1. Field of the Invention

The present invention relates to an adhesive sheet, which exhibits excellent adhesiveness, heat resistance, workability, handling properties and storage stability, and can be favorably used in flexible printed circuit boards and the like, as well as an acrylic adhesive composition that is useful in the production of such an adhesive sheet and a method of bonding two substrates using this acrylic adhesive sheet.

2. Description of the Prior Art

In recent years, miniaturization and weight reduction of electronic devices, and increases in circuit density have continued to progress, and the demand for multilayer FPCs, comprising 4 or more superimposed layers of flexible printed circuit boards (hereafter referred to as FPC), continues to increase. Multilayer FPCs are produced by using an adhesive sheet to laminate 2 or more single-sided copper foil or double-sided copper foil FPCs together, thus forming a multilayer structure. The adhesive sheet used in this layering of FPCs must satisfy required levels of certain characteristics such as adhesiveness, heat resistance, workability, handling properties, and storage stability, and further improvements in these characteristics are keenly sought.

Conventionally, examples of adhesive sheets that are widely used for FPCs include acrylonitrile butadiene rubber (hereafter referred to as NBR) adhesive sheets and acrylic adhesive sheets.

NBR adhesive sheets exhibit very good workability, but tend to be prone to reductions in adhesive strength due to thermal degradation and further suffer from poor storage stability (patent reference 1). Furthermore, acrylic adhesive sheets exhibit excellent adhesiveness, but suffer from poor workability, requiring press working at high temperatures for extended periods, as well as poor heat resistance (patent reference 2). In addition, acrylic adhesive sheets combining an epoxy resin, a resol-type phenol resin, and a curing accelerator are proposed, which exhibit excellent adhesiveness, heat resistance, and workability, but suffer from poor storage stability (patent reference 3).

Accordingly, obtaining an adhesive sheet that satisfies all of the aforementioned required characteristics simultaneously has proven to be extremely difficult.

[Patent Reference 1] JP 7-93497 B2

[Patent Reference 2] EP 0 201 102 A2

[Patent Reference 3] JP 2001-291964 A

### SUMMARY OF THE INVENTION

The present invention has an object of providing an acrylic adhesive sheet that resolves the problems described above and exhibits excellent adhesiveness, heat resistance, workability, handling properties and storage stability, as well as an acrylic adhesive composition that is useful in the production of such an adhesive sheet and a method of bonding two substrates using this acrylic adhesive sheet.

As a result of intensive research aimed at achieving the above object, the inventors of the present invention were able to complete the present invention. In other words, the present invention provides an acrylic adhesive composition, comprising:

(A) 100 parts by mass of an acrylic polymer containing a carboxyl group, with a glass transition temperature of 5 to 30° C.,

(B) 1 to 20 parts by mass of a resol-type phenol resin,

(C) 1 to 20 parts by mass of an epoxy resin, and

(D) 10 to 100 parts by mass of an inorganic filler,

said composition optionally comprising 0 to 0.5 parts by mass of a curing accelerator per 100 parts by mass of said component (A).

Furthermore, a second aspect of the present invention provides an acrylic adhesive sheet that contains an adhesive layer comprising the above composition.

A third aspect of the present invention provides a method of bonding two substrates using the above acrylic adhesive sheet.

By using an acrylic adhesive composition of the present invention, an acrylic adhesive sheet which contains an adhesive layer comprising the composition, and exhibits excellent adhesiveness, heat resistance, workability, handling properties and storage stability, can be produced. Short term pressing of this adhesive composition enables the preparation of adhesive sheets with excellent adhesiveness and heat resistance for use with FPCs, and particularly multilayer FPCs, meaning the composition is extremely useful.

### DETAILED DESCRIPTION OF THE PREFERRED EMBODIMENTS

As follows is a more detailed description of the present invention.

A composition of the present invention comprises the components (A) through (D) described below. The composition does not need to contain a curing accelerator, but may optionally comprises a curing accelerator in a limited amount or less, namely, in a amount of not higher than 0.5 parts by mass per 100 parts by mass of the component (A). In this description, acrylate esters and methacrylate esters, and acrylonitriles and methacrylonitriles are referred to using the generic terms “(meth)acrylate ester” and “(meth)acrylonitrile” respectively.

<(A) Acrylic Monomer Containing a Carboxyl Group>

The acrylic polymer of the component (A) contains a carboxyl group, and has a glass transition temperature of 5 to 30° C. This glass transition temperature is preferably from 10 to 25° C. Provided the glass transition temperature is from 5 to 30° C., the adhesive sheet described below, which contains an adhesive layer comprising the composition, exhibits satisfactory strength, and in some cases, the adhesive sheet may be able to be re-attached after temporary fastening, indicating excellent handling properties. If the glass transition temperature is less than 5° C., then an adhesive sheet with considerable tackiness and a low film strength results, meaning the handling properties are poor. Furthermore, if the glass transition temperature exceeds 30° C., then the adhesive sheet exhibits inferior adhesiveness. The glass transition temperature is measured using a differential scanning calorimeter (DSC).

An example of the acrylic polymer of this component is a copolymer comprising:
(a) a (meth)acrylate ester, and
(b) a carboxylic acid monomer containing a polymerizable unsaturated double bond.
   —(a) (meth)acrylate ester

The aforementioned (meth)acrylate ester imparts flexibility to the obtained adhesive sheet. Examples of this (meth)acrylate ester include both acrylate esters and methacrylate esters. Specific examples of acrylate esters include methyl acrylate, ethyl acrylate, n-butyl acrylate, isobutyl acrylate, isopentyl acrylate, n-hexyl acrylate, isooctyl acrylate, 2-ethylhexyl acrylate, n-octyl acrylate, isononyl acrylate, n-decyl acrylate, and isodecyl acrylate. Specific examples of methacrylate esters include methyl methacrylate, ethyl methacrylate, n-butyl methacrylate, isobutyl methacrylate, isopentyl methacrylate, n-hexyl methacrylate, isooctyl methacrylate, 2-ethylhexyl methacrylate, n-octyl methacrylate, isononyl methacrylate, n-decyl methacrylate, and isodecyl methacrylate. Of these, alkyl (meth)acrylates in which the number of carbon atoms in the alkyl group is within a range from 1 to 12, and preferably from 1 to 4, are particularly desirable. These (meth)acrylate esters can be used either alone, or in combinations of two or more different compounds.

The quantity of this (meth)acrylate ester, specifically the content within the acrylic polymer of the component (A), is typically within a range from 50 to 80% by mass, and preferably from 55 to 75% by mass. For quantities within this range, the flexibility of the adhesive sheet is superior, and runover of the composition during press working is less likely to occur.

—(b) Carboxylic acid monomer containing a polymerizable unsaturated double bond

The aforementioned carboxylic acid monomer containing a polymerizable unsaturated double bond imparts adhesiveness to the composition of the present invention, while also functioning as a cross-linking point during heating. Examples of this carboxylic acid monomer include acrylic acid, methacrylic acid, crotonic acid, maleic acid, fumaric acid, and itaconic acid, although acrylic acid and methacrylic acid are preferred. These carboxylic acid monomers can be used either alone, or in combinations of two or more different compounds.

The quantity of this carboxylic acid monomer containing a polymerizable unsaturated double bond, specifically the content within the acrylic polymer of the component (A), is typically within a range from 2 to 10% by mass, and preferably from 2 to 8% by mass. For quantities within this range, the adhesive sheet exhibits excellent levels of heat resistance and flexibility. Specifically, the level of cross-linking within the composition is adequate and appropriate, and the affinity of the adhesive sheet for the target adherend is favorable, meaning during processing of the adhesive sheet, foaming or blistering of the adhesive layer of the sheet is unlikely, even on heat curing treatment or solder bath treatment.

The component (A) may also contain other monomers that contain a polymerizable unsaturated double bond, in addition to the aforementioned monomers (a) and (b), and examples of these other monomers include (meth)acrylonitrile, ethylene, styrene, butadiene, and methyl vinyl ketone.

### EXAMPLE OF PREFERRED COPOLYMER

A preferred example of the acrylic polymer of this component is a copolymer comprising the aforementioned monomers (a) and (b), as well as (c) (meth)acrylonitrile. As follows is a description of this monomer (c).

—(c) (meth)acrylonitrile

The aforementioned (meth)acrylonitrile includes acrylonitrile and methacrylonitrile, and these may also be used in combination. The (meth)acrylonitrile imparts heat resistance, adhesiveness, and chemical resistance to the adhesive sheet.

In this preferred copolymer, the quantity of the monomer (a) is preferably from 50 to 80% by mass, and even more preferably from 55 to 75% by mass. The quantity of the monomer (b) is preferably from 2 to 10% by mass, and even more preferably from 2 to 8% by mass. The quantity of the monomer (c) is preferably from 15 to 45% by mass, and even more preferably from 20 to 40% by mass. Quantities within these respective ranges enable further improvements in the heat resistance and flexibility of the adhesive sheet.

The copolymer may be either a copolymer comprising only the monomers (a) through (c), or may also be a copolymer that also includes other monomers that contain a polymerizable unsaturated double bond.

The weight average molecular weight of the acrylic polymer of the component (A), reported as a measured value using gel permeation chromatography (GPC, calculated against a polystyrene reference), is preferably within a range from 100,000 to 1,000,000, and even more preferably from 300,000 to 600,000. Furthermore, the acrylic polymer can be prepared using normal solution polymerization, emulsion polymerization, suspension polymerization, or bulk polymerization methods.

The acrylic polymer of the component (A) can be used either alone, or in combinations of two or more different polymers.

<(B) Resol-Type Phenol Resin>

The resol-type phenol resin of the component (B) imparts thermosetting properties, adhesiveness, and heat resistance to the acrylic adhesive sheet. Furthermore, these properties become particularly excellent as a synergistic result of combining this component and an inorganic filler (D) described below. Specific examples of the resol-type phenol resin include resol-type phenol resins prepared using phenol or bisphenol A, alkylphenols such as p-t-butylphenol, octylphenol, or p-cumylphenol, or p-phenylphenol or cresol as starting materials.

The blend quantity of the component (B) must fall within a range from 1 to 20 parts by mass, and is preferably from 1 to 15 parts by mass, and even more preferably from 1 to 10 parts by mass, per 100 parts by mass of the component (A). If the blend quantity of the phenol resin is less than 1 part by mass, a product with unsatisfactory thermosetting properties results. If this blend quantity exceeds 20 parts by mass, then the adhesiveness of the adhesive sheet may deteriorate.

The resol-type phenol resin of the component (B) can be used either alone, or in combinations of two or more different resins.

<(C) Epoxy Resin>

The epoxy resin of the component (C) imparts thermosetting properties and adhesiveness to the acrylic adhesive sheet. This epoxy resin preferably contains an average of at least 2, and more preferably an average of 2 to 4, epoxy groups within each molecule, and the epoxy equivalence is preferably within a range from 100 to 1,000, and more preferably from 100 to 500. If the number of epoxy groups within each molecule and the epoxy equivalence both satisfy the above preferred ranges, then the resulting adhesive sheet exhibits not only excellent adhesiveness, but also satisfactory reactivity (namely, thermosetting properties). Furthermore, the molecular skeleton may also include phosphorus atoms, sulfur atoms, and nitrogen atoms and the like.

Examples of the epoxy resin of this component include bisphenol A-type epoxy resins and bisphenol F-type epoxy resins or hydrogenated products thereof, phenol novolac-type epoxy resins, cresol novolac-type epoxy resins, glycidyl amine-type epoxy resins, and aliphatic epoxy resins.

The blend quantity of the component (C) must fall within a range from 1 to 20 parts by mass, and is preferably from 1 to 15 parts by mass, per 100 parts by mass of the component (A). If this blend quantity is less than 1 part by mass, an adhesive sheet with unsatisfactory thermosetting properties results. If the blend quantity exceeds 20 parts by mass, the adhesive sheet undergoes excessive cross-linking and exhibits poor affinity for the target adhered, meaning when the adhesive sheet is processed, the adhesive layer of the sheet is prone to foaming or blistering on heat curing treatment or solder bath treatment.

The epoxy resin of the component (C) can be used either alone, or in combinations of two or more different resins.

<(D) Inorganic Filler>

The inorganic filler of the component (D) improves the heat resistance of the adhesive sheet. The inorganic filler preferably has electrical insulating properties and a higher level of elasticity than resins, and suitable examples include powdered fillers such as aluminum hydroxide, magnesium hydroxide, talc, alumina, magnesia, silica, titanium dioxide, calcium silicate, aluminum silicate, calcium carbonate, clay, silicon nitride, silicon carbide, aluminum borate, and synthetic mica and the like; short fibrous fillers such as glass, asbestos, rock wool, and aramid; and whiskers of silicon carbide, alumina, and aluminum borate and the like.

The blend quantity of the component (D) must fall within a range from 10 to 100 parts by mass, and is preferably from 15 to 90 parts by mass, per 100 parts by mass of the component (A). If this blend quantity is less than 10 parts by mass, then the heat resistance of the adhesive sheet may be inadequate. If the blend quantity exceeds 100 parts by mass, then the adhesiveness and heat resistance and the like of the adhesive sheet may deteriorate.

The inorganic filler of the component (D) can be used either alone, or in combinations of two or more different fillers.

<Other Components>

In addition to the components (A) through (D) described above, the composition of the present invention can contain other optional components where necessary.

—Curing Accelerator

The curing accelerator means those typically used for accelerating the reaction between the epoxy resin and the curing agent. Suitable examples of this curing accelerator include tertiary amines and imidazoles. Specific examples of suitable tertiary amines include triethylamine, benzyldimethylamine, and α-methylbenzyldimethylamine. Furthermore, specific examples of suitable imidazoles include 2-methylimidazole, 2-undecylimidazole, 2-ethyl-4-methylimidazole, 2-phenylimidazole, 2-phenyl-4-methylimidazole, 1-benzyl-2-methylimidazole, 1-cyanoethyl-2-methylimidazole, 1-cyanoethyl-2-ethyl-4-methylimidazole, 1-cyanoethyl-2-undecylimidazole, and 1-cyanoethyl-2-phenylimidazole.

Typically, the curing accelerator is often added to this kind of adhesive composition. However, in principle, it is unnecessary to add it to the composition of the present invention. If it is added, the quantity thereof should be controlled within a range where the effects of the present invention are not impaired. Specifically, the quantity should be 0.5 parts by mass or less and is preferably 0.1 parts by mass or less and particularly preferably 0.03 parts by mass or less, per 100 parts by mass of the component (A). Even more preferably, it is not added at all. If an excess of the curing accelerator is added, then the adhesive sheet obtained exhibits improved heat resistance, but suffer from markedly poor storage stability.

For example, to impart flame retardancy, halogen-based flame retardants, phosphorus-based flame retardants, and nitrogen-based flame retardants, and more specifically, flame retardants such as antimony trioxide and brominated epoxy resins can be used as other optional components.

<Composition Preparation>

Furthermore, the composition comprising the above components (A) through (D) and optional components may be used for producing an adhesive sheet without solvent, although the components may also be dissolved or dispersed in an organic solvent, thereby preparing the composition in the form of a solution or dispersion (hereafter, simply referred to as a solution). Examples of suitable organic solvents include N,N-dimethylacetamide, methyl ethyl ketone, N,N-dimethylformamide, cyclohexanone, N-methyl-2-pyrrolidone, toluene, methanol, ethanol, isopropanol, and acetone, and of these, methyl ethyl ketone, toluene, and cyclohexanone are preferred, and methyl ethyl ketone and toluene are particularly preferred. These organic solvents can be used either alone, or in combinations of two or more different solvents.

In preparing the composition, each of the above components and the organic solvent may be mixed together, for example, using a pot mill, ball mill, homogenizer, or super mill or the like.

<Adhesive Sheet>

An adhesive sheet of the present invention contains an adhesive layer (such as a film or the like) comprising a composition comprising each of the components described above, which may also comprise a protective layer on either one side or both sides of the adhesive layer. The thickness of the adhesive layer, in a dried state, is typically within a range from 10 to 100 μm, and is preferably from 15 to 75 μm.

—Protective Layer

There are no particular restrictions on the protective layer described above, provided it is able to be peeled off without damaging the adhesive layer, and typical examples of suitable films include plastic films such as polyethylene (PE) films, polypropylene (PP) films, polymethylpentene (TPX) films, release agent-coated polyethylene terephthalate (PET) films, and films in which PP is bonded to one surface or both surfaces of PET, as well as release sheets in which one or more of these films is coated onto one surface or both surfaces of a base paper (a paper material).

—Production Method

An aforementioned adhesive sheet can be prepared, for example, by molding a composition described above into a film-like form, or by applying the composition to a protective layer, drying the composition, and then bonding another protective layer on top.

Next is a description of a method of preparing an adhesive composition comprising an organic solvent, which represents a preferred embodiment of the present invention, and then producing an adhesive sheet with protective layers using this adhesive composition. First, an adhesive composition, prepared in a liquid form by mixing together each of the required components and an organic solvent, is applied to a protective layer using a reverse roll coater or a comma coater or the like. The protective layer with the applied adhesive composition is then passed through an in-line dryer, and heated at 60 to 140° C. for a short period (for example, 2 to 10 minutes), thereby removing the organic solvent, and drying the composition to form a semi-cured state, and yielding an adhesive sheet comprising an adhesive layer formed on one surface of the protective layer. A roll laminator is then used to crimp and laminate the adhesive layer of this adhesive sheet to another protective layer, thereby forming an adhesive sheet comprising protective layers on both surfaces of the adhesive layer. The term “semi-cured state” refers to any state from the point where the adhesive composition is dry, through to a point where the curing reaction has begun within portions of the composition.

—Bonding Method

An aforementioned adhesive sheet can be used for bonding two substrates. For this purpose, first, the adhesive sheet is sandwiched between the two substrates to form a laminate. Then, the adhesive sheet is cured to bond the two substrates.

There are no particular restrictions on the materials for the substrate. Examples thereof include a polyimide film and an electrolytic copper foil. Materials of the two substrates may be the same as or different from each other.

The adhesive sheet can be cured, for example, by heating said laminate at a temperature of 140 to 200° C. and preferably from 160 to 180° C. preferably under a pressure applied to said laminate in a direction perpendicular to the surface of said laminate. The pressure may be within a range from 2 to 4 MPa and preferably from 1 to 5 MPa. If the temperature and pressure fall within these ranges, the two substrates may be easily bonded through the cured adhesive sheet with excellent levels of peel strength (adhesiveness). The curing time may be within a range from about 0.5 to about 2 hours.

### EXAMPLES

As follows is a more detailed description of the present invention using a series of examples, although these examples in no way limit the scope of the present invention. Specifics of the components (A) through (D) and the other components used in the examples are as described below, and the conditions used for measuring the weight average molecular weight and the glass transition temperature in the examples are also as described below.

<Structural Components of Adhesive Compositions>

[(A) Acrylic Polymer]

(a) butyl acrylate, ethyl acrylate
(b) methacrylic acid
(c) acrylonitrile
   [(B) Resol-Type Phenol Resin]
(1) Phenolite J-325 (brand name) (a resol-type phenol resin, manufactured by Dainippon Ink and Chemicals Inc., theoretical OH equivalence=65)
(2) Phenolite 5592 (brand name) (an epoxy-modified resol-type phenol resin, manufactured by Dainippon Ink and Chemicals Inc., theoretical OH equivalence=72)
   [(C) Epoxy Resin]
(1) Epikote 1001 (brand name) (a bisphenol A-type epoxy resin, manufactured by Japan Epoxy Resins Co., Ltd., epoxy equivalence: 450 to 500, number of epoxy groups per molecule: 2)
(2) Epikote 154 (brand name) (a phenol novolac-type epoxy resin, manufactured by Japan Epoxy Resins Co., Ltd., epoxy equivalence: 176 to 180, number of epoxy groups per molecule: 3.5 to 4)
(3) Epikote 604 (brand name) (a glycidyl amine-type epoxy resin, manufactured by Japan Epoxy Resins Co., Ltd., epoxy equivalence: 110 to 130, number of epoxy groups per molecule: 4)
   [(D) Inorganic Filler]
(1) aluminum hydroxide
   [(other) Other Components]
(1) Phenolite TD-2093 (brand name) (a novolac-type phenol resin, manufactured by Dainippon Ink and Chemicals Inc., theoretical OH equivalence=104)
(2) Curezol 2E4MZ (brand name) (2-ethyl-4-methylimidazole, manufactured by Shikoku Corporation, curing accelerator)
   <Measurement Conditions>
   1. Weight Average Molecular Weight
GPC; brand name: HLC-8020, manufactured by Tosoh Corporation
Columns; brand names: TSKgel, GMH_{XL} (2 columns), manufactured by Tosoh Corporation, THF, calculated relative to polystyrene reference
   2. Glass Transition Temperature (Tg)
Differential scanning calorimeter; brand name: DSC-200, manufactured by Seiko Instruments Inc., rate of temperature increase: 5° C./minute

### Examples 1 to 8, Comparative Examples 1 to 8

The monomers (a) through (c) were mixed together in the blend quantities shown in the fields of Tables 1 and 2, and a 15% by mass methyl ethyl ketone (MEK) solution of the acrylic polymer of the component (A) was prepared in each case. Subsequently, taking the quantity of the acrylic polymer (namely, not including the mass of the MEK) as 100 parts by mass, adhesive compositions 1 to 8 and C1 to C8 were prepared by adding the other components of the adhesive composition in the blend quantities shown in the fields of Tables 1 and 2, and then mixing using normal methods.

Each of these adhesive compositions was applied to a protective layer, in sufficient quantity to produce a dried coating with a thickness of 25 μm. Subsequently, the organic solvent (MEK) contained within the adhesive composition was removed by heating at 120° C. for 10 minutes, thereby forming a semi-cured adhesive layer with a protective layer on one surface. A separate protective layer was then crimped onto the adhesive layer, thereby preparing the adhesive sheets 1 to 8 and C1 to C8 with protective layers on both surfaces of the adhesive layer.

<Measurement and Evaluation Methods>

The properties of these adhesive sheets were measured and evaluated according to the following methods. The results obtained are shown in Tables 1 and 2.

1. Peel Strength (Measurement of Adhesiveness)

The two surfaces of an adhesive sheet from which the protective layers had been removed were sandwiched between the polyimide films (brand name: Kapton 50H, manufactured by DuPont Corporation, thickness: 43.5 μm) of two single-sided FPC substrates, and the resulting structure was then press worked by applying a pressure of 3 MPa at a temperature of 160° C. for 40 minutes. The resulting pressed product was cut to a width of 10 mm, yielding a peel strength (polyimide-polyimide) measurement sample.

Furthermore, another adhesive sheet from which the protective layers had been removed was sandwiched between the polished surface of an electrolytic copper foil of thickness 35 μm on one surface, and a polyimide film (brand name: Kapton 100H, manufactured by DuPont Corporation) of thickness 25 μm on the other surface, and the resulting structure was then press worked by applying a pressure of 3 MPa at a temperature of 160° C. for 40 minutes. The resulting pressed product was cut to a width of 10 mm, yielding a peel strength (polyimide-copper foil) measurement sample.

Measurement of the peel strength was conducted in accordance with JIS C6471, by pulling the sample at an angle of 90 degrees and a speed of 50 mm/minute, thereby peeling the copper foil or the single-sided FPC substrate (that is, the polyimide film). The measured values of the peel strength are shown in the tables as “Initial state”.

2. Solder Heat Resistance (Measurement of Heat Resistance)

A peel strength (polyimide-copper foil) measurement sample prepared in the same manner as in “1. Peel strength” above was used as the solder heat resistance measurement sample. In accordance with JIS C6471, a sample comprising an electrolytic copper foil and a polyimide film bonded together was cut into a 25 mm square, thus yielding a sample specimen.

When the sample specimen was floated on a solder bath at 290° C. for 30 seconds, if no blistering or discoloration occurred on the adhesive layer, then the solder heat resistance was evaluated as “good”, whereas if blistering or discoloration occurred, then the solder heat resistance was evaluated as “poor”. The evaluations of the solder heat resistance are shown in the tables as “Initial state”.

3. Storage Stability

According to the measurement methods of the peal strength and solder heat resistance stated above, the peel strength and solder heat resistance were evaluated for a sample obtained by storing at 30° C. for three months the adhesive sheets prepared in Examples 1 to 8 and Comparative examples 1 to 8 and for a sample obtained by storing the adhesive sheets at 40° C. for one month. If there is no major change in the measured value of the peal strength and the solder heat resistance was good, then the storage stability of the adhesive sheet was evaluated as good. On the other hand, if, as a result of the storage above, the measured value of the peal strength of the adhesive sheet markedly decreased or the solder heat resistance was poor, then the storage stability was evaluated as poor.

4. Handling Properties of the Adhesive Sheet

—(4-1) Releasability of Adhesive Sheet From Protective Layer

When the protective layer was removed from the adhesive layer, if the protective layer was able to be removed without causing deformation in the adhesive sheet, then the releasability was evaluated as “good”, whereas if deformation such as elongation occurred, then the releasability was evaluated as “poor”.

—(4-2) Adhesive Sheet Reattachability

Reattachability refers to an ability to bond an adhesive sheet to a film or the like, remove the sheet, and then reattach it. In other words, even if an adhesive sheet that has been bonded to a film or the like needs to be removed in order to make a minor adjustment in position or the like, reattachability describes the property of being able to reattach the sheet. The reattachability of the adhesive sheet to the single-sided FPC polyimide film surface was tested, and sheets which exhibited favorable reattachability were recorded as “A”, whereas sheets for which the tackiness was high, and reattachment was impossible, were recorded as “B”.

<Adhesive Composition Blend Quantities, Test Results>

TABLE 1

| | | | Examples | | | | | | | |
|---|---|---|---|---|---|---|---|---|---|---|
| | | | 1 | 2 | 3 | 4 | 5 | 6 | 7 | 8 |
| A | Acrylic polymer | (a) butyl acrylate | 70 | 65 | 10 | 65 | 65 | 65 | 65 | 65 |
| | (parts by mass) | (a) ethyl acrylate | | | 50 | | | | | |
| | | (b) methacrylic acid | 5 | 5 | 5 | 5 | 5 | 5 | 5 | 5 |
| | | (c) acrylonitrile | 25 | 30 | 35 | 30 | 30 | 30 | 30 | 30 |
| | [Glass transition temperature (° C.)] | | 6 | 15 | 28 | 15 | 15 | 15 | 15 | 15 |
| | [Weight average molecular weight] | | 470,000 | 380,000 | 450,000 | 380,000 | 380,000 | 380,000 | 380,000 | 380,000 |
| B | Resol-type phenol resin | Phenolite J-325 | 2.0 | 5.0 | 10 | 12 | | | 5.0 | 5.0 |
| | (parts by mass) | Phenolite 5592 | | | | | 12 | 12 | | |
| C | Epoxy resin | Epikote 1001 | 5.0 | 10 | 15 | 18 | | | 10 | 10 |
| | (parts by mass) | Epikote 154 | | | | | 8.0 | | | |
| | | Epikote 604 | | | | | | 5.0 | | |
| D | Inorganic filler | Aluminum hydroxide | 40 | 40 | 40 | 40 | 40 | 40 | 20 | 80 |
| | (parts by mass) | | | | | | | | | |
| Prop- | Peel strength (N/cm) | (Initial state) | 18 | 17 | 17 | 16 | 16 | 16 | 16 | 18 |
| erties | (polyimide-copper foil) | (30° C./3 months) | 18 | 18 | 17 | 17 | 16 | 16 | 16 | 18 |
| | | (40° C./1 month) | 17 | 18 | 16 | 17 | 17 | 16 | 17 | 18 |
| | Peel strength (N/cm) | (Initial state) | 18 | 18 | 18 | 17 | 17 | 17 | 17 | 19 |
| | (polyimide-polyimide) | (30° C./3 months) | 18 | 18 | 18 | 17 | 17 | 17 | 17 | 18 |
| | | (40° C./1 month) | 18 | 17 | 18 | 16 | 16 | 16 | 16 | 19 |
| | Solder heat resistance | (Initial state) | Good | Good | Good | Good | Good | Good | Good | Good |
| | | (30° C./3 months) | Good | Good | Good | Good | Good | Good | Good | Good |
| | | (40° C./1 month) | Good | Good | Good | Good | Good | Good | Good | Good |
| | Adhesive sheet | Releasability | Good | Good | Good | Good | Good | Good | Good | Good |
| | | Reattachability | A | A | A | A | A | A | A | A |

TABLE 2

| | | | Comparative Examples | | | | | | | |
|---|---|---|---|---|---|---|---|---|---|---|
| | | | 1 | 2 | 3 | 4 | 5 | 6 | 7 | 8 |
| A | Acrylic polymer | (a) butyl acrylate | 75 | | 65 | 65 | 65 | 65 | 65 | 65 |
| | (parts by mass) | (a) ethyl acrylate | | 65 | | | | | | |
| | | (b) methacrylic acid | 5 | 5 | 5 | 5 | 5 | 5 | 5 | 5 |
| | | (c) acrylonitrile | 20 | 30 | 30 | 30 | 30 | 30 | 30 | 30 |
| | [Glass transition temperature (° C.)] | | 0 | 32 | 15 | 15 | 15 | 15 | 15 | 15 |
| | [Weight average molecular weight] | | 420,000 | 490,000 | 380,000 | 380,000 | 380,000 | 380,000 | 380,000 | 380,000 |
| B | Resol-type phenol resin | Phenolite J-325 | 5.0 | 5.0 | | 25 | 12 | 5.0 | 5.0 | 5.0 |
| | (parts by mass) | | | | | | | | | |
| C | Epoxy resin (parts by mass) | Epikote 1001 | 10 | 10 | 10 | 18 | 25 | 10 | 10 | 10 |
| D | Inorganic filler | Aluminum hydroxide | 40 | 40 | 40 | 40 | 40 | | 120 | 40 |
| | (parts by mass) | | | | | | | | | |
| Other | Novolac-type phenol resin | Phenolite TD-2093 | | | 5.0 | | | | | |
| | (parts by mass) | | | | | | | | | |
| | Curing accelerator | Curezol 2E4MZ | | | | | | | | 1.0 |
| | (parts by mass) | | | | | | | | | |
| Prop- | Peel strength (N/cm) | (Initial state) | 17 | 8 | 5 | 10 | 8 | 17 | 10 | 16 |
| erties | (polyimide-copper foil) | (30° C./3 months) | 17 | 8 | 5 | 9 | 7 | 17 | 10 | 13 |
| | | (40° C./1 month) | 18 | 6 | 4 | 9 | 7 | 17 | 9 | 10 |
| | Peel strength (N/cm) | (Initial state) | 20 | 8 | 5 | 8 | 7 | 17 | 10 | 16 |
| | (polyimide-polyimide) | (30° C./3 months) | 19 | 7 | 4 | 10 | 7 | 18 | 9 | 12 |
| | | (40° C./1 month) | 19 | 7 | 4 | 9 | 8 | 17 | 10 | 9 |
| | Solder heat resistance | (Initial state) | Good | Good | Poor | Poor | Poor | Poor | Good | Good |
| | | (30° C./3 months) | Good | Good | Poor | Poor | Poor | Poor | Good | Good |
| | | (40° C./1 month) | Good | Good | Poor | Poor | Poor | Poor | Good | Poor |
| | Adhesive sheet | Releasability | Poor | Good | Good | Good | Good | Good | Good | Good |
| | | Reattachability | B | A | A | A | A | A | A | A |

<Evaluations>

As is evident from Table 1 (the examples 1 to 8), an adhesive sheet containing an adhesive layer comprising an adhesive composition of the present invention exhibits excellent levels of peel strength (adhesiveness), solder heat resistance (heat resistance), workability, handling properties and storage stability. Furthermore, the composition also exhibits excellent workability, being able to be press worked in a short period of time even at temperatures that are not considered high temperatures.

In contrast, as is evident from Table 2 (the comparative examples 1 to 8), an adhesive sheet containing an adhesive layer comprising an adhesive composition that does not satisfy all of the conditions of the present invention displays inferior performance for at least one of the properties of peel strength (adhesiveness), solder heat resistance (heat resistance), workability, handling properties and storage stability. Furthermore, as is evident from the comparative example 8, if the curing accelerator is added to the above composition beyond the specified quantity, the adhesive sheet obtained displays inferior performance for storage stability.

What is claimed is:

1. An acrylic adhesive composition, comprising:
(A) 100 parts by mass of an acrylic polymer containing a carboxyl group, with a glass transition temperature of 5 to 30° C.,
(B) 1 to 20 parts by mass of a resol-type phenol resin,
(C) 1 to 20 parts by mass of an epoxy resin, and
(D) 10 to 100 parts by mass of an inorganic filler.

2. The composition according to claim 1, wherein said acrylic polymer (A) is a copolymer comprising:
(a) a (meth)acrylate ester,
(b) a carboxylic acid monomer containing a polymerizable unsaturated double bond, and
(c) (meth)acrylonitrile.

3. The composition according to claim 2, wherein said acrylic polymer (A) is a copolymer comprising from 50 to 80% by mass of said monomer (a), from 2 to 10% by mass of said monomer (b), and from 15 to 45% by mass of said monomer (c).

4. The composition according to claim 1, wherein said epoxy resin (C) contains an average of at least 2 epoxy groups within each molecule, and exhibits an epoxy equivalence of 100 to 1,000.

5. The composition according to claim 1, further comprising not higher than 0.5 parts by mass of a curing accelerator per 100 parts by mass of said component (A).

6. An acrylic adhesive sheet, containing an adhesive layer comprising the composition according to claim 1.

7. A method of bonding two substrates, comprising the steps of:
sandwiching the acrylic adhesive sheet according to claim 6 between said two substrates and
curing said acrylic adhesive sheet.
